(19) United States
(12) Patent Application Publication
(10) Pub. No.: US 2008/0104784 A1
(43) Pub. Date: May 8, 2008

(54) Offset-driven wiping system

(75) Inventor: Jerome Cerdan, Beaulieu (FR)

Correspondence Address: OSHA LIANG L.L.P., 1221 MCKINNEY STREET, SUITE 2800, HOUSTON, TX, 77010, US

(73) Assignee: Valeo Systemes d'Essuyage, La Verriere (FR)

(21) Appl. No.: 11/975,745

(22) Filed: Oct. 19, 2007

(30) Foreign Application Priority Data
Oct. 20, 2006 (FR) 0609229

(51) Int. Cl. B60S 1/04; B60S 1/34

(52) U.S. Cl. 15/103; 15/250.32

(57) ABSTRACT

The invention provides a wiping system of a motor vehicle glass panel, including a wiping blade assembly with a longitudinal main orientation, including a blade of the glass panel blade assembly pressure means on the glass panel, which exert a pression force on the rear end of the blade assembly, and where the pressure means exert on the blade assembly an additional force, where the additional force is produced so as to distribute the pressure of the wiping blade globally symmetrically with respect to the middle in the longitudinal direction of the blade assembly.

The invention provides a wiping system comprising a wiping blade assembly which is mounted on a free end of a driving arm through a joint connector fixed to an end of the blade assembly.

More particularly, the invention provides a wiping system of a motor vehicle glass panel, comprising a wiping blade assembly with a longitudinal main orientation, comprising a structural element in the form of a longitudinal horizontal strip and a longitudinal blade for wiping a horizontal top face of the glass panel, a driving arm of the blade assembly in alternating wiping movements, a front end of which is connected to a longitudinal rear end of the blade assembly through a joint connector of the blade assembly with respect to the arm around a transversal horizontal axis and a rear end of which is connected to a link head which is fixed to the free end of a driving shaft of the arm and the blade assembly in alternating wiping movements around the globally vertical axis, and blade assembly pressure means on the glass panel, which exert on the rear end of the blade assembly, through the driving arm, a pression force with a globally radial orientation with respect to the transversal axis. According to a classical embodiment, the driving arm is connected to the blade assembly by a connector which is globally mounted in the middle of the blade assembly.

This allows a homogeneous distribution of the pression forces of the blade assembly on the glass panel, so that the wiping is effective.

However, such an embodiment is unpleasant to see.

In order to improve the general aspect of the wiping system, it has been suggested to mount the joint connector at an end of the blade assembly, which is the closest one to the driving shaft.

Thus, the length of the driving arm is reduced, which gives the wiping system an improved aspect and discretion.

Document U.S. Pat. No. 6,651,292 describes such a type of wiping systems, for which the connector is mounted at the rear end of the blade assembly, and for which the length of the driving arm is reduced.

However, the pression force of the blade assembly on the glass panel, which is exerted through the driving arm, is equally distributed on either side of the transversal joint axis.

Thus, half of the pression force is applied to the portion of the blade assembly longitudinally located in front of the joint axis, and the other half of the pression force is applied to the portion of the blade assembly longitudinally located behind the transversal joint axis.

The assembly of the connector near the rear end of the blade assembly results in the length of the portion of the blade assembly located behind the transversal joint axis being relatively reduced and being much smaller than the length of the portion of the blade assembly located in front of the transversal joint axis.

Thus, half of the pression force which is applied to the portion of the blade assembly located behind the transversal axis is distributed on the small length of the rear portion of the blade assembly, and the other half of the pression force is distributed on the more important length of the front portion of the blade assembly.

The result is that the contact pressure of the portion of the blade, corresponding to the rear portion of the blade assembly, on the glass panel, is very important, which causes, in particular, a reduction in the useful life of the blade.

The object of the invention is to provide a wiping system for which the driving arm is connected to the blade assembly at the rear end of the blade assembly, and for which the pression forces of the blade assembly on the glass panel are homogeneously distributed throughout the length of the blade assembly.

For this purpose, the invention provides a wiping system such as previously described, characterized in that it comprises support means of the rear end of the blade assembly, so as to reduce the pression forces of the wiping blade on the glass panel, behind the transversal joint axis.

According to further characteristics of the invention:
the support means are arranged at the longitudinal rear end of the blade assembly;
the support means are integral with the blade assembly in alternating sweeping movements around the vertical axis;
the support means comprise a resilient element which is supported by the rear end of the blade assembly which cooperates with the link head;
the resilient element is a rear section of the structural element of the blade assembly, which longitudinally projects rearwards with respect to the rear end of the blade assembly;
the link head comprises a finger which extends globally longitudinally frontwards, the front free end of which presses upwards against the rear section of the structural element.

Further characteristics and advantages of the invention will appear from reading the following detailed description, for the understanding of which the appended figures can be consulted, in which:

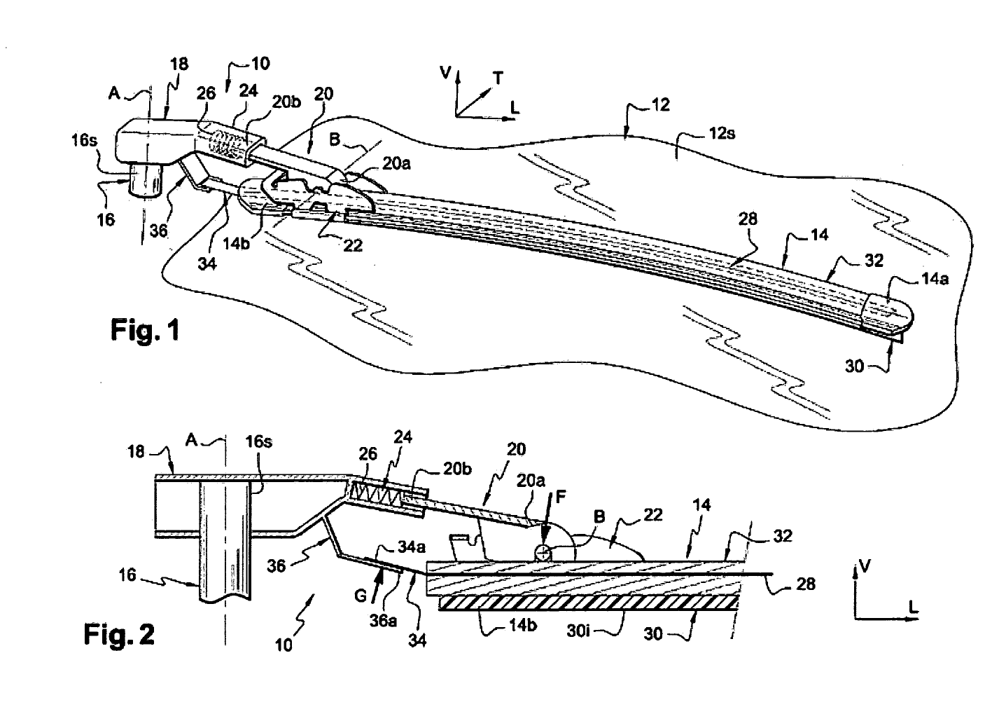

FIG. 1 is a diagrammatic perspective view of the wiping system according to the invention, comprising means to produce the additional force; and

FIG. 2 is a section following a longitudinal vertical plan of the wiping system shown in FIG. 1, showing the means to produce the additional force.

For the description of the invention, the vertical, longitudinal and transversal orientations will be adopted in a non limiting manner according to the reference frame V, L, T indicated in the figures.

The orientation front-to-rear will also be adopted as the longitudinal right-to-left direction according to FIG. 1.

In the following description, identical, similar or analogous elements will be referred to using the same reference numbers.

FIG. 1 shows a wiping system 10 of a glass panel 12, globally horizontal here, which comprises a blade assembly 14 with a longitudinal main orientation of the horizontal top face 12s of the glass panel 12 and driving means of the blade assembly 14 in alternating wiping movements with respect to the glass panel 12.

The blade assembly 14 is of a low, so-called “flat-blade” type, which comprises a structural element 28, or spine, in the form of a longitudinal horizontal strip, a longitudinal lower wiping blade 30 of the glass panel 12, and a link element 32 of the blade 30, with the structural element 28.

These driving means comprise a driving shaft 16 with a main axis A globally perpendicular to the glass panel 12, i.e. vertical here, the lower end of which (not shown) is connected to a driving mechanism (not shown) and the upper end 16s of which carries a link head 18.

The driving means also comprise a driving arm 20, a front end 20a of which is connected to the blade assembly 14 through a joint connector 22, and the rear end 20b of which is connected to the link head 18, so as to allow the blade assembly 14 to move globally vertically during its wiping movement, in order to adjust its vertical position to the curve of the glass panel 12.

Therefore, the driving means are made here so that the wiping movement of the blade assembly 14 with respect to the glass panel 12 consists in a rotation around the vertical main axis A of the shaft 16.

The rear end 20b of the arm 20 is connected to the link head so as to allow a vertical movement of the front end 20a of the arm 20 during its wiping movement, in order to adjust the vertical position of the blade assembly 14 to the curve of the glass panel 12.

The figures show an example of a link 18 between the rear end 20b of the arm 20 and the link head 18, according to which the rear end 20b of the arm 20 is slidingly mounted in a complementary housing 24 of the link head 18.

In this case, the housing 24 opens at its front end, and is globally oriented downwards and frontwards, as shown in FIG. 2. A resilient spring 26 is disposed in the housing 24 to push the arm 20 frontwards and downwards.

It should be understood that the invention is not limited to this embodiment of means linking the arm 20 to the head 18, and that the rear end 20b of the arm 20 can be connected to the link head 18 by other means.

The front end 20a of the arm 20 is connected to the blade assembly 14 through the connector 22, so that the blade assembly 14 is mounted such as to pivot with respect to the front end 20a of the arm 20 around the transversal axis B located at the front end 20a of the arm 20.

The connector 22 is mounted on the link element 32 of the blade assembly 14, for instance by vertically overlapping the link element 32.

Furthermore, to impart to the wiping system 10 a pleasant aesthetic aspect, the connector 22 is mounted near the longitudinal rear end 14b of the blade assembly 14. The length of the arm 20 is thus limited.

For the wiping blade 30 to rest on the upper face 12s of the glass panel 12, the arm 20 exerts a pression force on the blade assembly 14, through the connector 22, so that the pression force is oriented upwards and globally radially with respect to the transversal axis B, as schematically shown by the arrow F in FIG. 2._{f}

This pression force allows the lower edge 30i of the blade 30 to rest throughout its length against the upper face 12s of the glass panel 12.

However, the pression force F is equally distributed on either side of the transversal axis B, so that a first half of the pression force F is distributed on the portion of the blade assembly 14 located behind the transversal axis B, and a second half of the pression force F is distributed on the portion of the blade assembly 14 located in front of the transversal axis B.

Consequently, the pressure of the lower edge 30i of the wiping blade 30, behind the transversal axis B is relatively important due to the small length of this portion of the blade assembly 14 located behind the transversal axis B.

To reduce the value of this pressure of the portion of the lower edge 30i of the wiping blade 30, located behind the transversal axis B, and according to the invention, the wiping system 10 comprises support means of the rear end 14b of the blade assembly 14.

Thus, the first half of the pression force F is distributed, on the one hand, at the lower edge 30i of the wiping blade 30, located behind the transversal axis B, and on the other hand, on the support means.

For the aesthetic aspect of the wiping system 10 to remain relatively discrete, the support means are also arranged near the rear end 14b of the blade assembly 14.

According to the invention, the support means comprise a resilient means which is carried by the rear end 14b of the blade assembly 14 and which cooperates with a portion associated to the head 18.

Thus, the support means are integral with the blade assembly 14 during its wiping movement with respect to the glass panel 12, which allows to limit the pressure of the lower edge 30i of the wiping blade 30, located behind the transversal axis B, whatever the position of the blade assembly 14 is around the vertical axis A.

According to an alternative embodiment (not shown), the support means comprise a resilient means which is carried by the rear end 14b of the blade assembly 14 and which cooperates with a portion associated to the head 20.

As can be seen in the figures, the resilient element is formed by a rear section 34 of the spine 28 of the blade assembly 14, which longitudinally projects rearwards with respect to the rear end 14b of the blade assembly 14, and longitudinally extends frontwards beyond the rear end 14b of the blade assembly 14.

To cooperate with the rear section 34 of the spine 28, the link head 18 comprises a lower finger 36, which extends globally and longitudinally frontwards and which is arranged underneath the housing 24.

The longitudinal rear end 34a of the rear section 34 presses against the free front end of the lower finger 36, and the rear section 34 is resiliently deformed, so that its rear end 34a permanently exerts a force on the free end 36a of the finger 36 which is globally oriented downwards.

In compensation, the finger 36 exerts on the rear section 34 a force G oriented upwards. This is this force G that allows to limit the pressure of the rear end of the blade 30 on the upper face 12s of the glass panel 12.

Thus, the wiping system 10 according to the invention comprises the same number of components as a wiping system according to the prior art, while allowing a better distribution of the support pressure of the wiping blade 30 on the glass panel 12.

1. A wiping system of a motor vehicle glass panel comprising:
a wiping blade assembly with a longitudinal main orientation, comprising a structural element in the form of a longitudinal horizontal strip and a longitudinal blade of a horizontal top face of the glass panel;
a driving arm of the blade assembly in an alternating wiping movement, a front end of which is connected to a longitudinal rear end of the blade assembly through a joint connector of the blade assembly with respect to the arm around a transversal horizontal axis and a rear end of which is connected to a link head which is fixed to the free end of a driving shaft of the arm and the blade assembly in alternating wiping movements around a globally vertical axis; and
blade assembly pressure means on the glass panel, which exert on the rear end of the blade assembly, through the driving arm, a pression force with a globally radial orientation with respect to the transversal axis,
wherein the blade assembly pressure means comprises support means of the rear end of the blade assembly, so as to reduce the press forces of the wiping blade on the glass panel, behind the transversal axis.

2. The wiping system according to claim 1, wherein the support means are arranged at the longitudinal rear end of the blade assembly.

3. The wiping system according to claim 1, wherein the support means are integral with the blade assembly in alternating sweeping movements around the globally vertical axis.

4. The wiping system according to claim 1, wherein the support means comprise a resilient element supported by the rear end of the blade assembly, cooperates with the link head.

5. The wiping system according to claim 4, wherein the resilient element is a rear section of the structural element of the blade assembly, which longitudinally projects rearwards with respect to the rear end of the blade assembly.

6. The wiping system according to claim 5, wherein the link head comprises a finger which extends globally longitudinally frontwards, wherein a front free end of the finger presses upwards against the rear section of the structural element.
